(19) United States
(12) Patent Application Publication
(10) Pub. No.: US 2006/0081702 A1
(43) Pub. Date: Apr. 20, 2006

(54) System and method for universal consumer cards

(76) Inventor: Gopal Nandakumar, San Antonio, TX (US)

Correspondence Address: WAYNE J. COLTON, INC., The Milam Building Suite 1032, 115 East Travis Street, San Antonio, TX, 78205, US

(21) Appl. No.: 11/291,887

(22) Filed: Dec. 1, 2005

Related U.S. Application Data
(63) Continuation of application No. 10/352,695, filed on Jan. 27, 2003.

(51) Int. Cl. G06K 5/00; G06Q 40/00

(52) U.S. Cl. 235/380; 705/35

(57) ABSTRACT

A system and method for universal consumer cards includes a network of linked databases utilized to generate and maintain cross-references between universal consumer cards and a plurality of other traditional consumer cards. Consumers utilize the system by being issued a linked card of a similar physical character to a traditional credit card to the consumer. Once a universal card provider issues such a linked card to a consumer, other data pertinent to traditional consumer-type cards is linked to the universal linked card, which is then presented by the consumer is presented in place of the various traditional media. The merchant or organization presented with the linked card retrieves from one of the databases the necessary other data for completion of the consumer's desired transaction and completes the transaction as normal.

### RELATED APPLICATION

This present application claims priority under 35 U.S.C. § 120 as a continuation of Applicant's co-pending U.S. patent application Ser. No. 10/352,695 filed Jan. 27, 2003. By this reference, the full disclosure, including the claims and drawings, of U.S. patent application Ser. No. 10/352,695 is incorporated herein as though now set forth in its entirety.

### FIELD OF THE INVENTION

The present invention relates to consumer transaction processing. More particularly, the invention relates to a system and method whereby a plurality of consumer-type cards may be associated with a single or reduced number of universal consumer cards, thereby enabling consumer's to carry fewer cards for the conduct of consumer transactions.

### BACKGROUND OF THE INVENTION

It is not uncommon for consumers to be found with a wallet literally bulging with various bankcards, merchant cards, organizational membership cards, gift cards and other cards. While such cards provide a level of convenience to the consumer facilitating the fast and easy consummation of various transactions, it is nonetheless inconvenient for the consumer to have to carry a large number of the cards. It is therefore an overriding object of the present invention to improve upon the prior art by providing a system and method for implementing a universal consumer card whereby data from many traditional cards may be cross-referenced through a network of databases such that the consumer need only carry one or a few universal cards for the conduct of virtually any consumer transaction. Additionally, it is an object of the present invention to provide such a system and method that also provides enhanced features for both the consumer and accepting merchant or organization. Finally, it is an object of the present invention to provide such a system and method that may be implemented with little or no additional cost and with the full security generally found in traditional card systems.

### SUMMARY OF THE INVENTION

In accordance with the foregoing objects, the present invention—a system and method for universal consumer cards—generally comprises a network of linked databases utilized to generate and maintain cross-references between universal consumer cards and a plurality of other traditional consumer cards. Consumers may utilize the system by applying to a universal card provider for the issuance of a universal or “linked” card. Upon approval of the consumer's application, the universal card provider issues a linked card of a similar physical character to a traditional credit card to the consumer.

Once a universal card provider issues such a linked card to a consumer, other data pertinent to traditional consumer-type cards may be linked to the universal linked card. By way of example, and in no manner limiting of the present invention, such other traditional cards may include merchant credit cards, merchant prepaid cards, merchant gift cards, bank credit and/or debit cards, organizational membership cards and/or coupon cards. As will also be apparent further herein, it should be understood that a single universal linked card of the present invention may be utilized to consolidate data from any or all of the foregoing types of cards in any of a variety of combinations.

In any case, once the other data from traditional cards has been linked to the consumer's universal linked card, the linked card is presented in place of the various traditional media. In this manner, the consumer need only carry a single card for the conduct of any of a variety of transactions. The merchant or organization presented with the linked card then accesses, through terminal servers or the like, the network of databases according the unique identifying information embedded on the linked card in order to retrieve from one of the databases the necessary other data for completion of the consumer's desired transaction. Once this data has been retrieved, the merchant or other entity completes the transaction as normal.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a functional block diagram, the preferred embodiment of the universal card system of the present invention;

FIG. 2 shows, in a flowchart, a top-level overview of the preferred method of the present invention;

FIG. 3 shows, in a flowchart, details of one set of steps that may be utilized to associate traditional card data with a universal linked card;

FIG. 4 shows, in a flowchart, details of a second set of steps that may be utilized to associate traditional card data with a universal linked card;

FIG. 5 shows, in a flowchart, details of one set of steps that may be utilized to retrieve associated card data upon presentation for use of a universal linked card; and

FIG. 6 shows, in a flowchart, details of a second set of steps, particularly adapted for bankcard applications, that may be utilized to retrieve associated card data upon presentation for use of a universal linked card.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

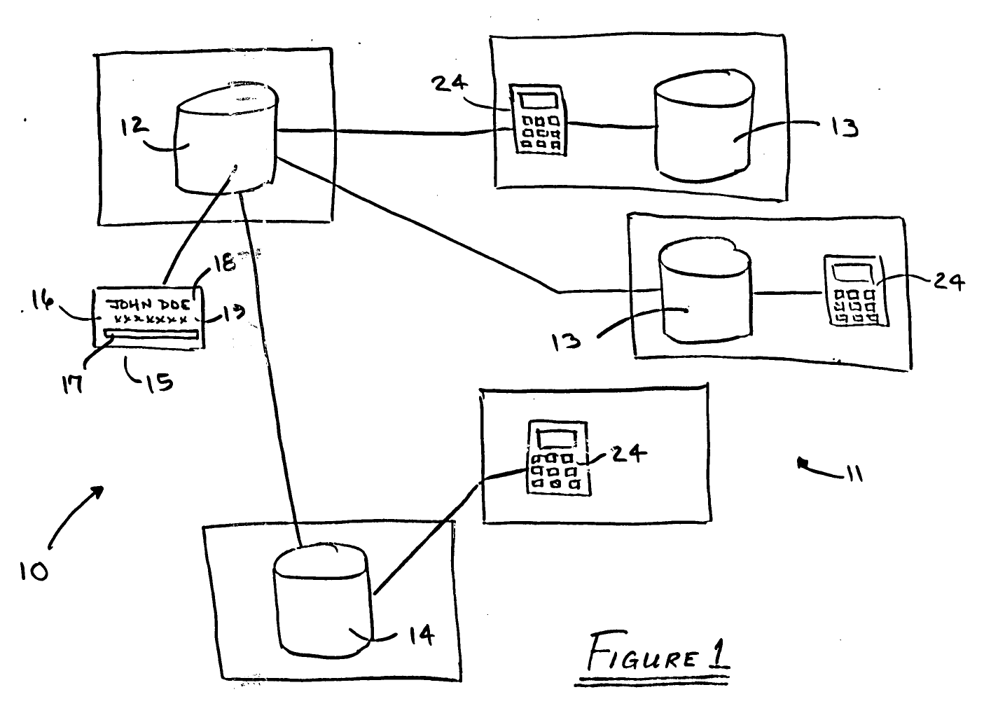

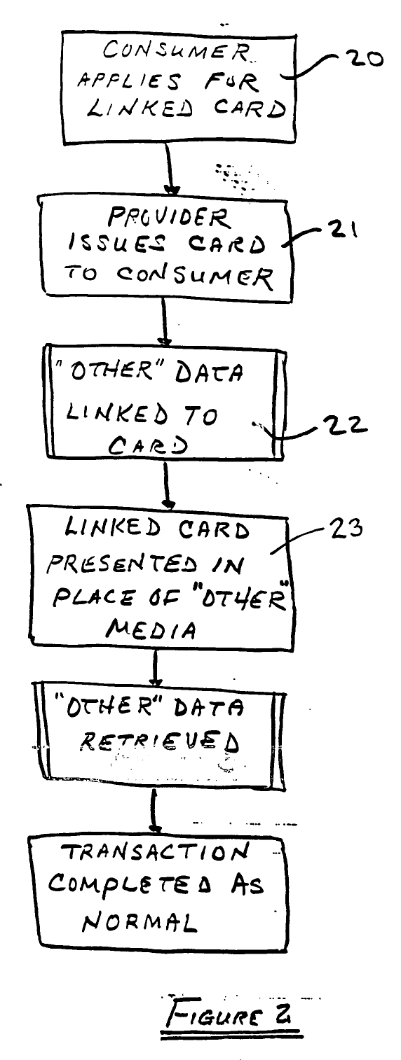

Referring now to FIG. 1, in particular, the preferred embodiment of the present invention 10 is shown to generally comprise a network 11 of linked databases 12, 13, 14 utilized to generate and maintain cross-references between universal consumer cards 15 and a plurality of other traditional consumer cards. As detailed in FIG. 2, consumers may utilize the system 10 of FIG. 1 by applying (step 20) to a universal card provider for the issuance of a universal or “linked” card 15. Upon approval of the consumer's application, the universal card provider issues (step 21) a linked card 15 (of a similar physical character to a traditional credit card) to the consumer.

Each linked card 15 comprises a unique identifying number 16, which is preferably stored within a magnetic stripe 17 incorporated on the linked card 15. Additionally, the linked card 15 may also have printed thereon the customer's name 18 and/or any other relevant or desired information 19. For reasons that will be more apparent further herein, the customer's name 18 and/or other relevant information 19, such as, for example, demographic data, may also be encoded within the magnetic stripe 17.

Once a universal card provider issues (step 21) such a linked card 15 to a consumer, other data pertinent to traditional consumer-type cards may be linked (step 22) to the universal linked card 15 as will be described in greater detail further herein. By way of example, and in no manner limiting of the present invention, such other traditional cards may include merchant credit cards, merchant prepaid cards, merchant gift cards, bank credit and/or debit cards, organizational membership cards and/or coupon cards. As will also be apparent further herein, it should be understood that a single universal linked card 15 of the present invention may be utilized to consolidate data from any or all of the foregoing types of cards in any of a variety of combinations.

Once the other data from traditional cards has been linked (step 22) to the consumer's universal linked card 15, the linked card 15 is presented (step 23) in place of the various traditional media. In this manner, the consumer need only carry a single card 15 for the conduct of any of a variety of transactions. The merchant or organization presented with the linked card then accesses, through terminal servers 24 or the like, the network 11 of databases 12, 13, 14 according the unique identifying information embedded on the linked card 15 in order to retrieve from one of the databases 12, 13, 14 the necessary other data for completion of the consumer's desired transaction. Once this data has been retrieved, the merchant or other entity completes the transaction as normal.

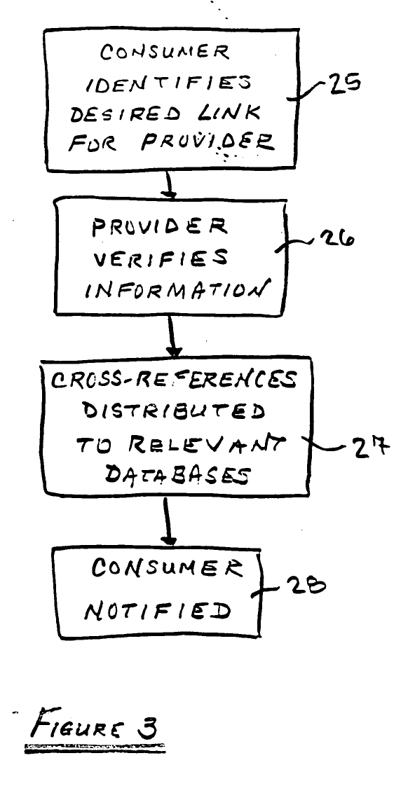

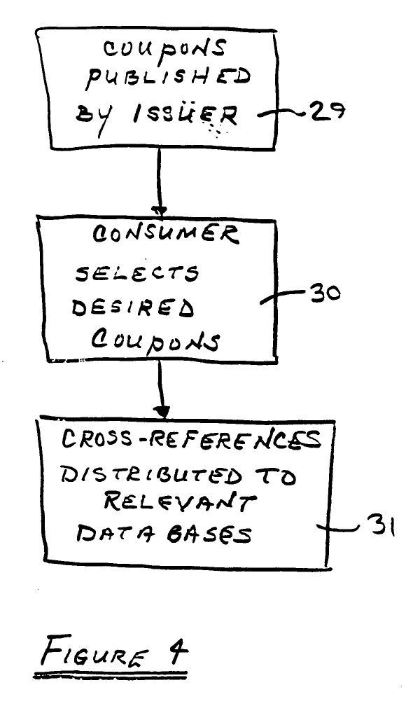

As shown in FIGS. 3 and 4, the other data may be linked to the universal linked card 15 under the supervision of the card provider, for high-security applications such as the linking of merchant, bank or membership cards, or by the consumer directly, for relatively safe transactions such as the identification of coupons that the consumer desires to utilize. In the former, as detailed in FIG. 3, the consumer identifies (step 25) the desired link for the provider by giving the provider the merchant, bank or organization name and/or identifying number; the consumer's merchant card, bank card or membership card number; and any appropriate security code. The card provider then verifies (step 26) this information with the appropriate merchant, bank or organization whereafter the card provider generates and disseminates (step 27) to the relevant databases 12, 13, 14 cross-reference entries tying the traditional cards to the linked card 15. The consumer is then notified (step 28) that the desired link has been completed and that the universal linked card 15 may thereafter be used in lieu of the traditional card.

As shown in FIG. 4, lower security applications, such as the coupon application, will not generally require provider intervention for making the desired cross-reference. In such cases, coupons or sales may simply be published (step 29) by the issuer on the Internet, in newspapers or in any other media. The consumer may then select (step 30) the desired coupons and thereafter instigate (step 31) the desired cross-references directly. For example, as in the case of coupons published on the Internet, the consumer may simply enter his or her universal link card number into a submission box provided adjacent the coupon display on the Internet web page. In the alternative, a special web page may be provided for submission by the consumer of his or her linked card number and one or more coupon numbers taken from print media. In either case, submission through the Internet preferably leads to direct and instantaneous cross-referencing in the relevant databases 12, 13, 14.

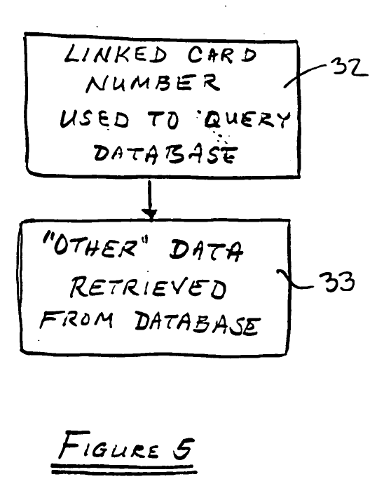

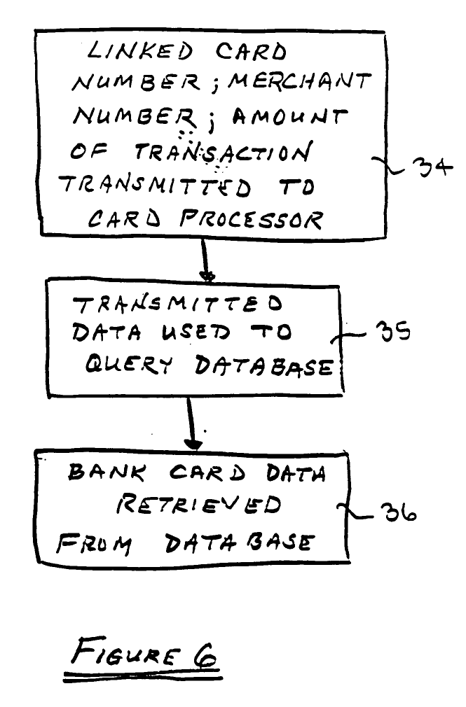

As shown in FIG. 5, most transactions will be completed by making a simple query (step 32) into either the card provider's database 12 or the merchant's or organization's database 13 with the linked card number for retrieval (step 33) of the relevant other data. As shown in FIG. 6, however, some further processing may be required in the case of bankcards. For example, a merchant accepting a linked card 15 in place of a bankcard will transmit (step 34) the linked card number, the merchant's merchant number and the amount of the transaction to the card processor as normal. The card processor, however, then utilizes (step 35) this transmitted data to query either the processor's database 14 or the provider's database 12 in order to retrieve (step 36) appropriate bankcard data. The retrieved data will primarily depend upon the types of bankcards accepted by the merchant and the amount of the transaction. Additionally, however, the retrieved data may depend upon consumer preferences as relayed to the universal linked card provider at the time various bankcards are associated with the linked card. For example the consumer may be allowed to specify a preferential bankcard for use with merchants accepting multiple cards. In this manner, the consumer may be allowed to maximize participation in promotional programs such as frequent flyer programs requiring the use of a particular bankcard.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, the system and method of the present invention may be utilized in categories of cards or to combine features of various cards to provide entirely new functionality. For example, allowing the consumer to associate coupon information with his or her universal linked card 15 having also bankcard capabilities allows the discounts associated with the linked coupons to be taken automatically at the register as the card is being used to tender payment. Likewise, provision on the universal card 15 or in the various databases 12, 13, 14 of personal and demographic data relevant the consumer allows stores to capture survey type information without requiring the consumer to recite his or her telephone number, address or other personal information in the presence of other consumers. Additionally, use of the universal card 15 for coupon redemption allows the merchant to gather information about the consumer taking advantage of particular promotional offerings, thereby allowing the merchant to better target advertising. In any case, because the scope of the present invention is much broader than any particular embodiment, the foregoing detailed description should not be construed as a limitation of the scope of the present invention, which is limited only by the claims appended hereto.

What is claimed is:

1. A method for consolidating multiple consumer cards into a single universal consumer card, said method comprising the steps of:
issuing an organizational membership card to a consumer, said organizational membership card comprising a unique identifier;
generating a cross-reference entry between a traditional consumer card and said organizational membership card in a database, said cross-reference entry comprising data pertinent to said traditional consumer card; and
retrieving said data from said database based upon said unique identifier.

2. The method as recited in claim 1, wherein said traditional card comprises a gift card.

3. A method for consolidating consumer transaction data through a single consumer card, said method comprising the steps of:
issuing an organizational membership card to a consumer, said organizational membership card comprising a unique identifier;
generating a cross-reference entry between a traditional consumer program and said organizational membership card in a database, said cross-reference entry comprising data pertinent to said traditional consumer program; and
retrieving said data from said database based upon said unique identifier.

4. The method as recited in claim 3, wherein said traditional program comprises a gift program.
